(19) United States
(12) Patent Application Publication
(10) Pub. No.: US 2022/0223073 A1
(43) Pub. Date: Jul. 14, 2022

(54) DISPLAY DEVICE

(71) Applicant: BOE TECHNOLOGY GROUP CO., LTD., Beijing (CN)

(72) Inventor: Zifeng WANG, Beijing (CN)

(21) Appl. No.: 17/610,199

(22) PCT Filed: Dec. 3, 2020
(86) PCT No.: PCT/CN2020/133630

§ 371 Date: Nov. 10, 2021

(30) Foreign Application Priority Data
Dec. 5, 2019 (CN) 201922181463.3

(51) Int. Cl. G09F 9/30; G06F 1/20; G06F 1/26

(52) U.S. Cl. CPC G09F 9/301; G06F 1/266; G06F 1/20

(57) ABSTRACT

A display device includes a display module, a backplane assembly, a bracket assembly (3) and a system circuit assembly. The display module includes a display panel, and the display panel has a light exit surface and a back surface opposite to the light exit surface. The backplane assembly is disposed on a side of the display panel facing away from the light exit surface, and the backplane assembly is fixed to the display module. A surface of the backplane assembly away from the display module is fixed to the bracket assembly. The bracket assembly has a hollow region. The system circuit assembly is fixed in the hollow region of the bracket assembly, and the system circuit assembly is electrically connected to the display module. The system circuit assembly is configured to provide signals to the display module to make the display module.

### CROSS-REFERENCE TO RELATED APPLICATIONS

This application is a national phase entry under 35 USC 371 of International Patent Application No. PCT/CN2020/133630, filed on Dec. 3, 2020, which claims priority to Chinese Patent Application No. 201922181463.3, filed on Dec. 5, 2019, which are incorporated herein by reference in their entirety.

### TECHNICAL FIELD

The present disclosure relates to the field of display technologies, and in particular, to a display device.

### BACKGROUND

An organic electroluminescent diode (also called organic light-emitting diode, OLED) display is a flexible display device made of organic electroluminescent diodes, which has a good display effect and a wide operating temperature range, may realize self-luminescence, and thus has a good application prospect.

Compared to a liquid crystal display (LCD), the OLED display has good bending properties, so that the OLED display may be used for curved display.

### SUMMARY

In an aspect, a display device is provided. The display device includes a display module, a backplane assembly, a bracket assembly, and a system circuit assembly. The display module includes a display panel, and the display panel has a light exit surface and a back surface opposite to the light exit surface. The backplane assembly is disposed on a side of the display panel facing away from the light exit surface, and the backplane assembly is fixed to the display module. A surface of the backplane assembly away from the display module is fixed to the bracket assembly. The bracket assembly has a hollow region. The system circuit assembly is fixed in the hollow region of the bracket assembly, and the system circuit assembly is electrically connected to the display module. The system circuit assembly is configured to provide signals to the display module to make the display module display.

In some embodiments, at least one side wall of the system circuit assembly has a plurality of external interfaces. A side wall of the system circuit assembly has a wire passing port, and internal signal lines connected to the display module pass through the wire passing port to be electrically connected to the system circuit assembly. The backplane assembly has an opening configured to allow the internal signal lines to pass through to be electrically connected to the display module.

In some embodiments, the system circuit assembly includes a carrying box, a box cover, and a system circuit board. The carrying box includes a carrying box body and a plurality of fixing portions disposed on at least two opposite side edges of the carrying box body. The plurality of fixing portions extend outside the carrying box body, and the plurality of fixing portions are configured to be connected to the bracket assembly. The box cover is fixed to the carrying box to form a receiving chamber. The system circuit board is disposed in the receiving chamber.

In some embodiments, a plurality of heat dissipation holes are disposed in the box cover.

In some embodiments, the carrying box body includes a bottom plate, a first side wall and a second side wall. The bottom plate includes a first edge and a second edge that are oppositely arranged, and a third edge and a fourth edge that are oppositely arranged. The first side wall and the second side wall are disposed at the first edge and the second edge, respectively, and the first side wall and the second side wall are connected to the bottom plate as a whole. At least one of the plurality of fixing portions is connected to the third edge as a whole, and remaining fixing portion(s) of the plurality of fixing portions are connected to the fourth edge as a whole. The carrying box further includes a third side wall and a fourth side wall. The third side wall and the fourth side wall are disposed at the third edge and the fourth edge, respectively. The third side wall located at the third edge is fixed to the first side wall and the second side wall, and/or the bottom plate. The fourth side wall located at the fourth edge is fixed to the first side wall and the second side wall, and/or the bottom plate. The plurality of external interfaces are disposed in the fourth side wall.

In some embodiments, the carrying box further includes a plurality of connection fixing members disposed on the first side wall and the second side wall. The plurality of connection fixing members are configured to make the box cover be fixed to the first side wall and the second side wall.

In some embodiments, the bracket assembly includes a support portion, two edge-covering brackets, and at least two detachable fixing structures. The support portion extends in a first direction. The two edge-covering brackets are disposed on two sides of the support portion in the first direction, respectively. Each edge-covering bracket extends in a second direction, and an end of the edge-covering bracket away from the support portion is a flanging portion. The first direction is an extending direction of a side of the light exit surface, the second direction is an extending direction of another side of the light exit surface, and the side and the another side are two adjacent sides of the light exit surface. The edge-covering bracket is fixed to a corresponding end of the support portion through at least one detachable fixing structure. One of the edge-covering bracket and an end of the support portion has at least one through hole, and each detachable fixing structure passes through a through hole to be fixed to another one. An outer wall of the detachable fixing structure and a hole wall of the through hole have a gap therebetween, so as to enable the edge-covering bracket and the support portion to be relatively moved when the support portion is assembled with the edge-covering bracket. The surface of the backplane assembly away from the display module is in contact with and fixed to the support portion, and the two edge-covering brackets are located at two side edges of the display module in the first direction.

In some embodiments, the edge-covering bracket further includes a connection portion, and the connection portion and the flanging portion form an L-shaped structure. The connection portion includes a first connection sub-portion and a second connection sub-portion, and the first connection sub-portion is located between the second connection sub-portion and the flanging portion, and is connected to the second connection sub-portion and the flanging portion. The second connection sub-portion and the end of the support portion are stacked in a thickness direction of the bracket assembly, and the first connection sub-portion is non-overlapped with the support portion in the thickness direction of the bracket assembly. The at least one through hole is disposed in the second connection sub-portion.

In some embodiments, the support portion includes at least two support members, and any two adjacent support members of the at least two support members are arranged at an interval in the second direction, and an end of each support member is fixed to the edge-covering bracket through at least one detachable fixing structure. The bracket assembly further includes at least one bracket disposed between the two edge-covering brackets, and each bracket extends in the second direction. The at least one bracket is fixedly connected to the at least two support members. The system circuit assembly is disposed in the hollow region enclosed by two adjacent support members and the at least one bracket.

In some embodiments, the support member is in an arcuate shape, and a surface of the support member that is in contact with the surface of the backplane assembly away from the display module is an arc-shaped surface. An extending direction of a curved side of the arc-shaped surface is parallel to the first direction. The arc-shaped surface and the flanging portion are located on a same side of the bracket assembly.

In some embodiments, a side of at least one support member away from the backplane assembly is provided with a groove, and the groove penetrates through the support member in the second direction. And/or, the support member is further provided with at least one heat dissipation window, and the at least one heat dissipation window penetrates through the support member in the second direction.

In some embodiments, a plurality of mounting holes are disposed in a surface of the bracket assembly facing the backplane assembly. A plurality of protrusions are disposed on a surface of the backplane assembly facing the bracket assembly, and the plurality of protrusions are configured to be matched with the plurality of mounting holes.

In some embodiments, the display module further includes two protection bezels, and the two protection bezels are disposed on two side edges of the display panel that are oppositely arranged in a second direction. Each protection bezel is fixed to one of two side faces of the display panel that are oppositely arranged in the second direction.

In some embodiments, the protection bezel includes a side bezel, a clamping portion connected to the side bezel, and a position-limiting platform disposed on a side of the clamping portion away from the display panel. The clamping portion is disposed between the backplane assembly and the display panel. The side bezel is fixed to the side face of the display panel. An edge portion of the backplane assembly is disposed on a surface of the clamping portion away from the display panel.

In some embodiments, the display module further includes at least one first driving circuit board disposed on at least one of two side edges of the display panel that are oppositely arranged in the second direction. Each first driving circuit board is located on the back surface of the display panel, and extends beyond an edge of the display panel. The first driving circuit board is located between the side bezel, the clamping portion and the display panel.

In some embodiments, the display module further includes at least one second driving circuit board disposed on at least one of two side edges of the display panel that are oppositely arranged in a first direction, and each second driving circuit board is located on the back surface of the display panel. An orthogonal projection of the second driving circuit board on the backplane assembly is located in a range of an orthogonal projection of the display panel on the backplane assembly.

In some embodiments, the backplane assembly includes a backplane and at least one connection structure disposed on a side surface of the backplane proximate to the display panel. The display panel is fixed to the backplane through the at least one connection structure.

In some embodiments, the display module further includes a control circuit board disposed on the back surface of the display panel. The display device has a central region and an edge region around the central region. The at least one connection structure is disposed in the central region, and the control circuit board is disposed in the edge region.

In some embodiments, the backplane assembly further includes an insulating sheet disposed on the side surface of the backplane proximate to the display panel. An orthogonal projection of the insulating sheet on the display module covers the control circuit board.

In some embodiments, the at least one connection structure includes a plurality of connection structures, and the plurality of connection structures are arranged in an array.

### BRIEF DESCRIPTION OF THE DRAWINGS

In order to describe technical solutions in the present disclosure more clearly, the accompanying drawings to be used in some embodiments of the present disclosure will be introduced briefly below. Obviously, the accompanying drawings to be described below are merely accompanying drawings of some embodiments of the present disclosure, and a person of ordinary skill in the art may obtain other drawings according to these drawings. In addition, the accompanying drawings to be described below may be regarded as schematic diagrams, but are not limitations on an actual size of a product, an actual process of a method, and an actual timing of a signal involved in the embodiments of the present disclosure.

FIG. 1 is a front exploded view of a display device, in accordance with some embodiments;

FIG. 2 is a front view of a display device, in accordance with some embodiments;

FIG. 3 is a perspective exploded view of a display device, in accordance with some embodiments;

FIG. 4A is a sectional view of the region indicated by C in FIG. 3;

FIG. 4B is another sectional view of the region indicated by C in FIG. 3;

FIG. 5 is a sectional view of an edge-covering bracket, in accordance with some embodiments;

FIG. 6A is a structural diagram of a display panel and a backplane assembly before bending, in accordance with some embodiments;

FIG. 6B is a structural diagram of a display panel and a backplane assembly after bending, in accordance with some embodiments;

FIG. 7 is a top view of a back surface of a display module, in accordance with some embodiments;

FIG. 8A is a sectional view taken along the A-A′ direction in FIG. 7;

FIG. 8B is a sectional view taken along the B-B′ direction in FIG. 7;

FIG. 9A is a distribution diagram of protrusions in a backplane assembly, in accordance with some embodiments;

FIG. 9B is a schematic diagram of protrusions and mounting holes, in accordance with some embodiments;

FIG. 10A is a front structural view of a backplane assembly, in accordance with some embodiments;

FIG. 10B is a rear structural view of a display module, in accordance with some embodiments;

FIG. 11A is a front structural view of another backplane assembly, in accordance with some embodiments;

FIG. 11B is a rear structural view of another display module, in accordance with some embodiments;

FIG. 12 is a sectional view taken along the C-C′ direction in FIG. 11A;

FIG. 13 is a top view of an assembly structure of a display module and a backplane assembly, in accordance with some embodiments;

FIG. 14A is a sectional structural view of a display module and a backplane assembly, in accordance with some embodiments;

FIG. 14B is another sectional structural view of a display module and a backplane assembly, in accordance with some embodiments;

FIG. 14C is yet another sectional structural view of a display module and a backplane assembly, in accordance with some embodiments;

FIG. 15 is yet another sectional structural view of a display module and a backplane assembly, in accordance with some embodiments;

FIG. 16 is a structural diagram of a system circuit assembly, in accordance with some embodiments; and

FIG. 17 is an exploded view of a system circuit assembly, in accordance with some embodiments.

### DETAILED DESCRIPTION

Technical solutions in some embodiments of the present disclosure will be described clearly and completely below with reference to the accompanying drawings. Obviously, the described embodiments are merely some but not all embodiments of the present disclosure. All other embodiments obtained by a person of ordinary skill in the art on a basis of the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as an open and inclusive meaning, i.e., “including, but not limited to”. In the description of the specification, the terms such as “one embodiment”, “some embodiments”, “exemplary embodiments”, “an example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

Hereinafter, the terms “first” and “second” are only used for descriptive purposes, and are not to be construed as indicating or implying the relative importance or implicitly indicating the number of indicated technical features. Thus, a feature defined with “first” or “second” may explicitly or implicitly include one or more of the features. In the description of the embodiments of the present disclosure, the term “a plurality of/the plurality of” means two or more unless otherwise specified.

In the description of some embodiments, the term “connected” and its extensions may be used. For example, the term “connected” may be used in the description of some embodiments to indicate that two or more components are in direct physical or electrical contact with each other. However, the term “connected” may also mean that two or more components are not in direct contact with each other, but still cooperate or interact with each other. The embodiments disclosed herein are not necessarily limited to the contents herein.

The phrase “at least one of A, B and C” has the same meaning as the phrase “at least one of A, B or C”, both including the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

The use of the phrase “applicable to” or “configured to” indicates an open and inclusive meaning, which does not exclude devices that are applicable to or configured to perform additional tasks or steps.

In addition, the use of the phrase “based on” means openness and inclusiveness, in that a process, step, calculation or other action “based on” one or more of the stated conditions or values may, in practice, be based on additional conditions or values exceeding those stated.

The term “about” or “approximately” as used herein includes a stated value and an average value within an acceptable range of deviation of a particular value determined by a person of ordinary skill in the art, considering measurement in question and errors associated with measurement of a particular quantity (i.e., limitations of a measurement system).

Exemplary embodiments are described herein with reference to sectional views and/or plan views as idealized exemplary drawings. In the accompanying drawings, thicknesses of layers and regions are enlarged for clarity. Therefore, the exemplary embodiments should not be construed to be limited to the shapes of the layers and the regions shown herein, but to include the deviations due to, for example, manufacturing. In addition, the layers and the regions shown in the accompanying drawings are schematic in nature, and their shapes are not intended to show actual shapes of the regions in a device, and are not intended to limit the scope of the exemplary embodiments.

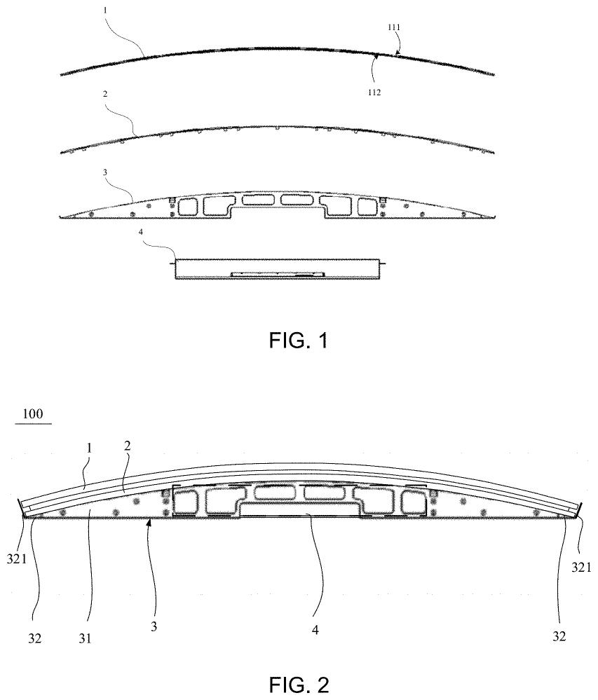

As shown in FIGS. 1 to 3, some embodiments of the present disclosure provide a display device 100. The display device 100 includes a display module 1, a backplane assembly 2, a bracket assembly 3, and a system circuit assembly 4. The display module 1 includes a display panel 11. The display panel 11 has a light exit surface 111 and a back surface 112 opposite to the light exit surface 111. The backplane assembly 2 is provided on a side of the display panel 11 facing away from the light exit surface 111, and the backplane assembly 2 is fixed to the display module 1. A surface of the backplane assembly 2 away from the display module 1 is fixed to the bracket assembly 3, and the bracket assembly 3 has a hollow region 3A. The system circuit assembly 4 is fixed in the hollow region 3A of the bracket assembly 3, and the system circuit assembly 4 is electrically connected to the display module 1. The system circuit assembly 4 is configured to provide signals to the display module 1 to make the display module 1 display.

The display device 100 may be used as a product or a component with any display function, such as a mobile phone, a tablet computer, a personal digital assistant (PDA), a digital photo frame, a navigator, or a vehicle-mounted computer. The application of the display device is not particularly limited in the embodiments of the present disclosure.

In some embodiments, the display panel 11 is a flexible display panel. In some examples, the display panel 11 is a flexible self-luminous display panel. For example, the display panel 11 is an organic electroluminescent diode (also called organic light-emitting diode, OLED) display panel. Of course, the display panel 11 may also be another type of display panel. The display panel 11 in the embodiments of the present disclosure is not limited to be the flexible display panel.

It will be noted that the display device 100 in the embodiments of the present disclosure may be a flat display device or a curved display device. In a case where the display device 100 is the curved display device, the display panel 11 is the flexible display panel.

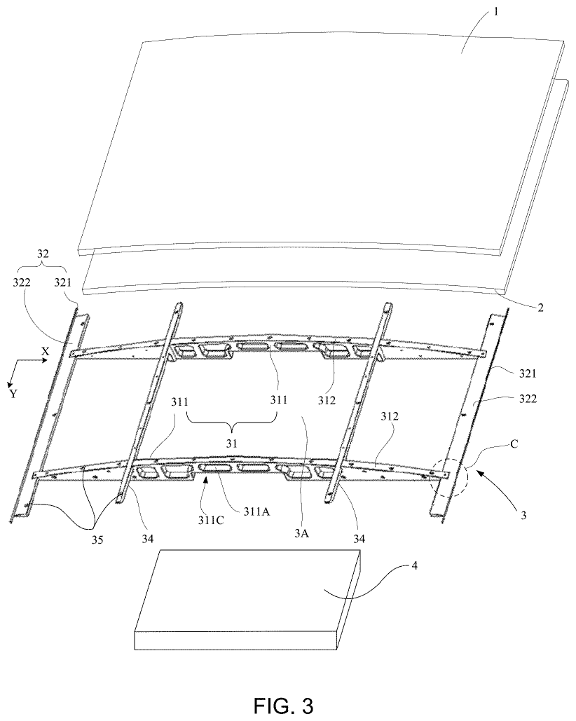

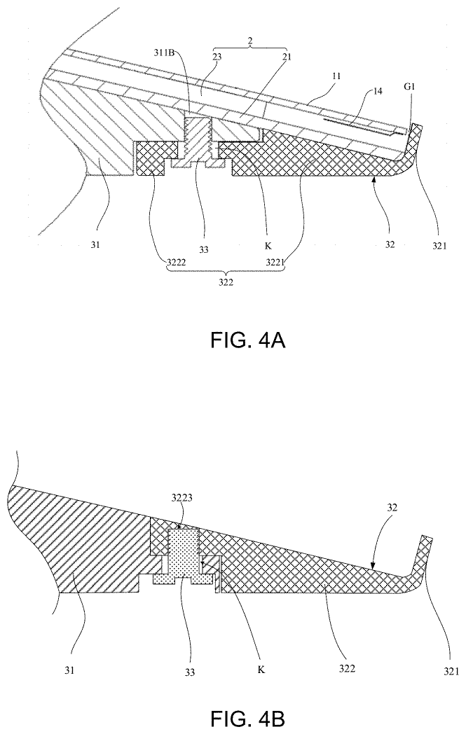

In some embodiments, as shown in FIGS. 3, 4A and 4B, the bracket assembly 3 includes a support portion 31, two edge-covering brackets 32, and at least two detachable fixing structures 33.

As shown in FIG. 3, the support portion 31 extends in a first direction X. The two edge-covering brackets 32 are provided on two sides of the support portion 31 in the first direction X, respectively. Each edge-covering bracket 32 extends in a second direction Y, and an end of the edge-covering bracket 32 away from the support portion 31 is a flanging portion 321. The first direction X is an extending direction of a side of the light exit surface 111, the second direction is an extending direction of another side of the light exit surface 111, and the side and the another side are two adjacent sides of the light exit surface 111. For example, the first direction X is an extending direction of a long side of the light exit surface 111, and the second direction Y is an extending direction of a short side of the light exit surface 111.

As shown in FIGS. 4A and 4B, each edge-covering bracket 32 is fixed to a corresponding end of the support portion 31 through at least one detachable fixing structure 33. That is, one of the two edge-covering brackets 32 is fixed to an end of the support portion 31 through at least one detachable fixing structure 33, and another one of the two edge-covering brackets 32 is fixed to another end of the support portion 31 through at least one detachable fixing structure 33. Accordingly, the two edge-covering brackets 32 are connected to each other through the support portion 31. In some embodiments, the edge-covering bracket 32 is fixed to the corresponding end of the support portion 31 through a plurality of detachable fixing structures 33.

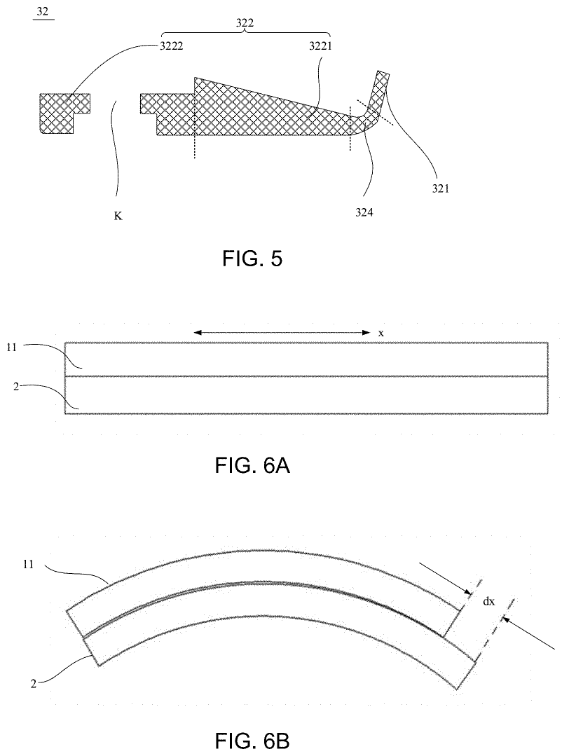

As shown in FIGS. 4A and 4B, one of each edge-covering bracket 32 and the end of the support portion 31 has at least one through hole K, and each detachable fixing structure 33 passes through the through hole K to be fixed to another one. In some examples, as shown in FIGS. 4A and 5, the edge-covering bracket 32 has at least one through hole K, and each detachable fixing structure 33 passes through the through hole K to be fixed to the end of the support portion 31. In some other examples, as shown in FIG. 4B, the end of the support portion 31 has at least one through hole K, and each detachable fixing structure 33 passes through the through hole K to be fixed to the edge-covering bracket 32. In some examples, in a case where the edge-covering bracket 32 is fixed to the corresponding end of the support portion 31 through one detachable fixing structures 33, one of the edge-covering bracket 32 and the end of the support portion 31 has one through hole K, and the detachable fixing structure 33 passes through the through hole K to be fixed to another one. In some other examples, one of the edge-covering bracket 32 and the end of the support portion 31 has a plurality of through holes K, the plurality of through holes K are in one-to-one correspondence with the plurality of detachable fixing structures 33, and each detachable fixing structure 33 passes through a corresponding through hole K to be fixed to another one.

An outer wall of the detachable fixing structure 33 and a hole wall of the through hole K have a gap therebetween, so as to enable the edge-covering bracket 32 and the support portion 31 to be relatively moved when the support portion 31 is assembled with the edge-covering bracket 32, thereby adjusting a relative position between the edge-covering bracket 32 and the support portion 31. In some embodiments, the edge-covering bracket 32 is moved relative to the support portion 31 in the first direction X when the support portion 31 is assembled with the edge-covering bracket 32, and after the adjustment of the relative position between the edge-covering bracket 32 and the support portion 31 is finished, the edge-covering bracket 32 and the support portion 31 are completely locked by the detachable fixing structure(s) 33, so that the relative movement between the edge-covering bracket 32 and the support portion 31 does not occur any more.

It will be noted that a maximum distance of the relative movement between the edge-covering bracket 32 and the support portion 31 may be set according to actual needs. Based on this, a size of the through hole K and a size of the detachable fixing structure 33 are reasonably set according to a set maximum distance.

When the bracket assembly 3 is used for being assembled with the backplane assembly 2 and the display module 1, the backplane assembly 2 and the display module 1 are arranged on a side of the support portion 31 in a thickness direction of the bracket assembly 3. The flanging portions 321 of the two edge-covering brackets 32 are located at two sides of the display module 1 in the first direction X, and accordingly, the flanging portions 321 of the two edge-covering brackets 32 are located at two sides of the backplane assembly 2 in the first direction X. Each flanging portion 321 is opposed to one of two opposite side faces of the display module 1 in the first direction X, so as to protect the side face. In some examples, a distance between the flanging portion 321 and the side face of the display module 1 is less than or equal to a preset width. The preset width may be set according to actual conditions. For example, the preset width is less than or equal to 1 mm. Since the relative position of the edge-covering bracket 32 and the support portion 31 is adjustable, a distance between the flanging portions 321 of the two edge-covering brackets 32 is adjustable. Thus, the distance between the flanging portion 321 and the side face of the display module 1 is adjustable, so that the distance may be adjusted to be within a required range. By providing the detachable fixing structures 33 in the bracket assembly 3, when the bracket assembly 3 is assembled with the backplane assembly 2 and the display module 1, the relative position between the edge-covering bracket 32 and the support portion 31 in the first direction X may be adjusted at any time through the operation of the detachable fixing structure(s) 33.

For the curved display device, both the display panel 11 and the backplane assembly 2 are curved. As shown in FIGS. 6A and 6B, in some examples, due to different materials and characteristics of the display panel 11 and the backplane assembly 2, the display panel 11 and the backplane assembly 2 that are originally in a planar structure and assembled together have different deformation capabilities in a bending process, so that a side face of the display panel 11 and a corresponding side face of the backplane assembly 2 (the side face and the corresponding side face are located on a same side of the display panel 11 and a same side of the backplane assembly 2) after bending have a certain misalignment. Moreover, as a bending degree of the display panel 11 and the backplane assembly 2 increases, this misalignment becomes more and more severe.

For example, as shown in FIG. 6B, the display panel 11 and the backplane assembly 2 are bent downward. An extending direction of a curved side of a surface of the display panel 11 away from the backplane assembly 2 is parallel to the first direction X, and an extending direction of an unbent side of the surface of the display panel 11 away from the backplane assembly 2 is parallel to the second direction Y. Due to the different deformation capacities of the display panel 11 and the back plate 2 in the bending process, a deviation dx is present between the side face of the display panel 11 and the corresponding side face of the backplane assembly 2 in the first direction X, so that the side face of the display panel 11 cannot be aligned with the corresponding side face of the backplane assembly 2.

Although the deviation may be controlled when the display panel 11 and the backplane assembly 2 are manufactured, and a misalignment degree may be reduced to some extent, the misalignment of the display panel 11 and the backplane assembly 2 after bending is still inevitable, in that a curvature radius of the curved display device during actual bending and a curvature radius during design cannot be completely matched. Moreover, a degree of the deviation itself is also poor in consistency, and different deviations may be presented on different curved display devices.

As shown in FIG. 4A, in an assembly process of the display device in the embodiments of the present disclosure, since the relative position of the edge-covering bracket 32 and the support portion 31 is adjustable, the relative position of the edge-covering bracket 32 and the support portion 31 may be adjusted according to actual situations of the curved display device, thereby adjusting the distance G1 between the flanging portion 321 and the side face of the display module 1. Thus, the distance G1 may be adjusted to be within a specified range, so that edge gaps of different display devices 100 are approximately equal to meet consistency requirements of industrial production.

In some embodiments, as shown in FIGS. 4A and 4B, the edge-covering bracket 32 further includes a connection portion 322 in addition to the flanging portion 321, and the connection portion 322 and the flanging portion 321 form an L-shaped structure. The connection portion 322 and the end of the support portion 31 are stacked in the thickness direction of the bracket assembly 3, and the at least one through hole K is provided in one of the connection portion 322 and the end of the support portion 31. In some examples, as shown in FIG. 4A, the at least one through hole K is provided in the connection portion 322, and each detachable fixing structure 33 passes through the through hole K to be fixed to the end of the support portion 31. In some other examples, as shown in FIG. 4B, the at least one through hole K is provided in the end of the support portion 31, and each detachable fixing structure 33 passes through the through hole K to be fixed to the connection portion 322.

As shown in FIG. 5, in some examples, an angle formed by connecting the connection portion 322 and the flanging portion 321 is an arc-shaped chamfer 324. In this way, the connection portion 322 and the flanging portion 321 are smoothly transitioned at a connecting position to avoid stress concentration, thereby improving structural performances. In addition, burrs may also be avoided to prevent the backplane assembly 2 from being damaged.

In some examples, as shown in FIGS. 4A and 5, the connection portion 322 includes a first connection sub-portion 3221 and a second connection sub-portion 3222. The first connection sub-portion 3221 is located between the second connection sub-portion 3222 and the flanging portion 321, and the first connection sub-portion 3221 is connected to the second connection sub-portion 3222 and the flanging portion 321. The second connection sub-portion 3222 and the end of the support portion 31 are stacked in the thickness direction of the bracket assembly 3, and the first connection sub-portion 3221 is non-overlapped with the support portion 31 in the thickness direction of the bracket assembly 3. In the embodiments in which the at least one through hole K is provided in the connection portion 322, the at least one through hole K is provided in the second connection sub-portion 3222.

In some embodiments, as shown in FIG. 4A, at least one threaded hole (for convenience of description, the threaded hole is referred to as a first threaded hole 311B below) is provided in a side of the end of the support portion 31 facing the second connection sub-portion 3222. The detachable fixing structure 33 includes a threaded fastener, and the threaded fastener passes through the through hole K disposed in the second connection sub-portion 3222 to be fixedly connected to a corresponding first threaded hole 311B. Here, the first threaded hole 311B may or may not penetrate through the end of the support portion 31.

In some examples, as shown in FIG. 4A, the through hole K is a counterbore, and the threaded fastener is provided in the counterbore. The threaded fastener does not protrude from a side of the second connection sub-portion 3222 away from the support portion 31, so that an outer surface of the bracket assembly 3 is flat.

In some other examples, the through hole K is a waist-shaped hole, and a length of the through hole K in the first direction X is greater than a width of the through hole K in the second direction Y.

For example, the threaded fastener is a bolt. The bolt includes a threaded rod and a nut. The threaded rod of the bolt extends into the first threaded hole 311B after passing through the through hole K. A depth of the threaded rod into the support portion 31 gradually increases by rotating the threaded rod. When a surface of the nut facing the threaded rod is pressed against the second connection sub-portion 3222 and a surface of the second connection sub-portion 3222 facing the support portion 31 is also pressed against the support portion 31, the edge-covering bracket 32 is fixedly connected to the support portion 31.

For another example, the threaded fastener is a double-end stud. The detachable fixing structure 33 further includes a nut, and the nut is sleeved on one end of the double-end stud. Another end of the double-end stud extends into the first threaded hole 311B after passing through the through hole K. A depth of the double-end stud into the support portion 31 gradually increases by rotating a threaded rod. When a surface of the nut facing the support portion 31 is pressed against the second connection sub-portion 3222 and the surface of the second connection sub-portion 3222 facing the support portion 31 is also pressed against the support portion 31, the edge-covering bracket 32 is fixedly connected to the support portion 31.

In some other embodiments, as shown in FIG. 4B, the end of the support portion 31 has the at least one through hole K, and at least one second threaded hole 3223 is provided in a side of the connection portion 322 of the edge-covering bracket 32 facing the end of the support portion 31. The detachable fixing structure 33 includes a threaded fastener, and the threaded fastener passes through the through hole K disposed in the end of the support portion 31 to be fixedly connected to a corresponding second threaded hole 3223. Here, the second threaded hole 3223 may or may not penetrate through the connection portion 322. An exemplary structure of the threaded fastener may refer to the above, which will not be repeated here.

In some embodiments, as shown in FIG. 4A, a surface of the support portion 31 away from the backplane assembly 2 is provided with a notch groove at each of the two ends of the support portion 31 in the first direction X. The second connection sub-portion 3222 is provided in the notch groove.

In some examples, as shown in FIG. 4A, a surface of the connection portion 322 away from the backplane assembly 2 and the surface of the support portion 31 away from the backplane assembly 2 are located in the same plane. After the edge-covering brackets 32 are assembled with the support portion 31, the surface of the connection portion 322 away from the backplane assembly 2 and the surface of the support portion 31 away from the backplane assembly 2 constitute the outer surface of the bracket assembly 3, so that the outer surface of the bracket assembly 3 is flat. In this way, the outer surface of the bracket assembly 3 may be directly placed on a mounting table, and the bracket assembly 3 may be used as a jig for assembling the display module 1 and the backplane assembly 2, thereby reducing additional jigs.

In some embodiments, as shown in FIG. 3, a surface of the support portion 31 proximate to the backplane assembly 2 is an arc-shaped surface. An extending direction of a curved side of the arc-shaped surface is parallel to the first direction X, and the arc-shaped surface and the flanging portion 321 are located on a same side of the bracket assembly 3. Based on this, the support portion 31 may be adapted and connected to the curved backplane assembly 2, so that the bracket assembly 3 may be applied to the curved display device.

In some examples, as shown in FIG. 4A, a surface of the first connection sub-portion 3221 proximate to the backplane assembly 2 is an inclined surface, and the inclined surface is tangent to an edge of the arc-shaped surface of the support portion 31 proximate to the inclined surface. In this way, the inclined surface and the edge of the arc-shaped surface may be smoothly transitioned without a sharp transition portion. Accordingly, when the backplane assembly 2 is in contact with a transition portion of the inclined surface and the arc-shaped surface, the backplane assembly 2 may not be scratched by the transition portion.

As shown in FIG. 3, in some embodiments, the support portion 31 includes at least two support members 311, and any two adjacent support members 311 of the at least two support members 311 are arranged at an interval in the second direction Y. An end of each support member 311 is fixed to one edge-covering bracket 32 through at least one detachable fixing structure 33, and another end is fixed to another edge-covering bracket 32 through at least one detachable fixing structure 33. Here, the two edge-covering brackets 32 are connected by at least two support members 311 to form a stable assembly structure.

As shown in FIG. 3, in some examples, the support member 311 is in an arcuate shape, and a surface of the support member 311 that is in contact with the surface of the backplane assembly 2 away from the display module 1 is an arc-shaped surface. An extending direction of a curved side of the arc-shaped surface is parallel to the first direction X, and the arc-shaped surface and the flanging portion 321 are located on a same side of the bracket assembly 3.

On this basis, in some examples, as shown in FIG. 3, the bracket assembly 3 further includes at least one bracket 34, and each bracket 34 extends in the second direction Y. The at least one bracket 34 is provided between the two edge-covering brackets 32, and the at least one bracket 34 is fixedly connected to the at least two support members 311. The system circuit assembly 4 is arranged in the hollow region 3A enclosed by two adjacent support members 311 and at least one bracket 34.

In some examples, the at least one bracket 34 includes two brackets 34, and the two brackets 34 are arranged at an interval in the first direction X. The system circuit assembly 4 is arranged in the hollow region 3A enclosed by two adjacent support members 311 and the two brackets 34.

In some examples, a distance between one of the two brackets 34 and a corresponding edge-covering bracket 32 is equal to a distance between another bracket 34 and another corresponding edge-covering bracket 32.

In some examples, as shown in FIG. 3, each support member 311 is provided with at least one heat dissipation window 311A, and the at least one heat dissipation window 311A penetrates through the support member 311 in the second direction Y. On one hand, by providing the heat dissipation window(s) 311A, the support member 311 may be hollowed out, so as to reduce a weight of the support member 311 without affecting structural performances of the support member 311. On another hand, the heat dissipation window 311A may serve as a storage space for other components, so as to increase a storage capacity of the bracket assembly 3. On yet another hand, the heat dissipation window 311A may serve as a heat dissipation channel to increase a heat dissipation speed and enhance a heat dissipation capability of the bracket assembly 3.

In some examples, as shown in FIG. 3, a surface of the bracket assembly 3 facing the backplane assembly 2 is provided with a plurality of mounting holes 35, and the plurality of mounting holes 35 and the flanging portions 321 are located on a same side of the bracket assembly 3. For example, the plurality of mounting holes 35 are provided on the support portion 31, the bracket(s) 34 and the edge-covering brackets 32. As shown in FIGS. 9A and 9B, a plurality of protrusions 211 are provided on a side of the backplane assembly 2 facing the support portion 31 of the bracket assembly 3. The plurality of protrusions 211 are configured to be matched with the plurality of mounting holes 35 to enable the bracket assembly 3 and the backplane assembly 2 to be quickly positioned. For example, as shown in FIG. 9B, the plurality of protrusions 211 are in one-to-one correspondence with the plurality of mounting holes 15, and each protrusion 211 may be inserted into one mounting hole 15 to form a shaft and hole positioning relationship. For example, the plurality of mounting holes 211 are uniformly distributed, and accordingly, the plurality of protrusions 211 are uniformly distributed, so that a connection force between the bracket assembly 3 and the backplane assembly 2 is uniformly dispersed to avoid stress concentration.

In some embodiments, the support portion 31, the bracket 34, and the edge-covering bracket 32 are sheet metals, or are injection molded.

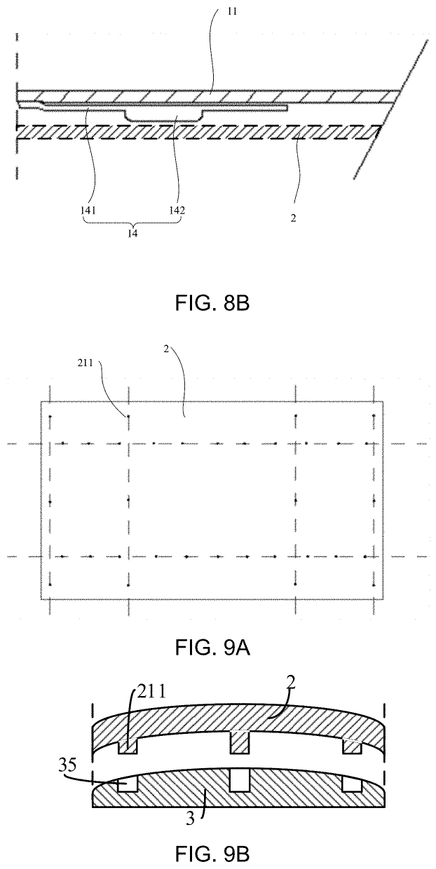

In some embodiments, as shown in FIG. 8A, the display module 1 further includes two protection bezels 12. The two protection bezels 12 are provided on two side edges of the display panel 11 that are oppositely arranged in the second direction Y, and each protection bezel 12 is fixed to one of two side faces of the display panel 11 that are oppositely arranged in the second direction Y. In this way, on the basis of protecting the side face of the display panel 11, a gap between the protection bezel 12 and the side face of the display panel 11 may be reduced or eliminated, so as to improve a reliability of the display device 100 and ensure an aesthetic appearance of the display device 100.

For example, the protection bezel 12 is fixed to the display panel 11 by adhesion.

In some examples, as shown in FIG. 8A, the protection bezel 12 includes a side bezel 121, a clamping portion 122 connected to the side bezel 121, and a position-limiting platform 123 disposed on a side of the clamping portion 122 away from the display panel 11. The clamping portion 122 is provided between the display panel 11 and the backplane assembly 2, and the side bezel 121 is fixed to the side face of the display panel 11 (e.g., the side bezel 121 is fixed to the side face of the display panel 11 by adhesion). For example, the protection bezel 12 is made of an elastic material. The clamping portion 122 may be elastically deformed, and thus a generated elastic force enables the clamping portion 32 to be fixed between the display panel 11 and the backplane assembly 2.

An edge portion of the backplane assembly 2 is provided on a surface of the clamping portion 122 away from the display panel 11, and a gap dy is provided between a side face of the backplane assembly 2 located at the edge portion and a side wall of the position-limiting platform 123. In this way, it is possible to avoid an extrusion between the protection bezel 12 and the backplane assembly 2 and a displacement of the protection bezel 12 caused by the extrusion, thereby ensuring that the protection bezel 12 and the side face of the display panel 11 are able to be in a reliable contact.

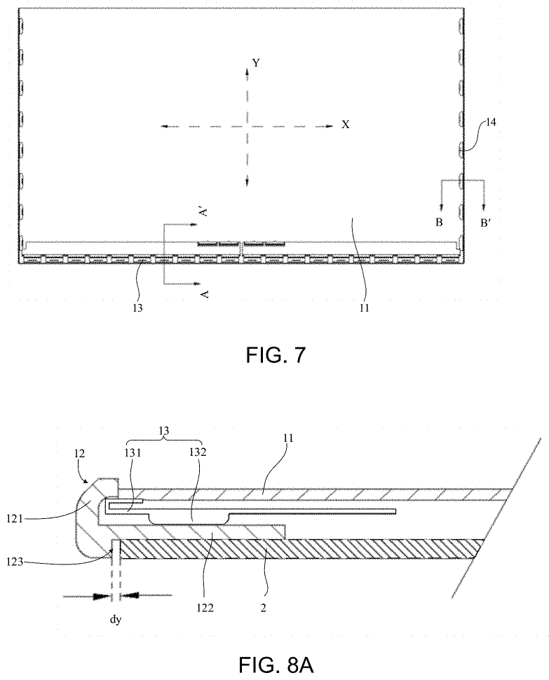

In some embodiments, as shown in FIGS. 7 and 8A, the display module 1 further includes at least one first driving circuit board 13. The at least one first driving circuit board 13 is provided on at least one of two side edges of the display panel 11 that are oppositely arranged in the second direction Y. In some examples, as shown in FIG. 7, the display module 1 includes a plurality of first driving circuit boards 13. The plurality of first driving circuit boards 13 are provided on one of the two side edges of the display panel 11 that are oppositely arranged in the second direction Y. In some other examples, the display module 1 includes a plurality of first driving circuit boards 13. A part of the plurality of first driving circuit boards 13 are provided on one of the two side edges of the display panel 11 that are oppositely arranged in the second direction Y, and the remaining part of the plurality of the first driver circuit boards 13 are provided on another one of the two side edges of the display panel 11 that are oppositely arranged in the second direction Y.

As shown in FIG. 8A, each first driving circuit board 13 is located on the back surface 112 of the display panel 11, and extends beyond the edge of the display panel 11. The first driving circuit board 13 is located between the side bezel 121, the clamping portion 122 and the display panel 11. In this way, it is possible to ensure that the first driving circuit board 13 does not expose outside the display module 1. On one hand, the first driving circuit board 13 may be protected, and on another hand, a neat and aesthetic appearance of the display module 1 is ensured.

For example, the first driving circuit board 13 includes a first film 131 and a source driving integrated circuit (IC) 132 disposed on the first film 131, and the source driving IC 132 is located on a side of the first film 131 away from the display panel 11. When the first driving circuit board 13 is fixed, an end of the first film 131 is fixed to the back surface 112 of the display panel 11, and the remaining portion protudes outside the display panel 11, and then is folded back to the back surface 112 side of the display panel 11.

In some embodiments, as shown in FIGS. 7 and 8B, the display module 1 further includes at least one second driving circuit board 14. The at least one second driving circuit board 14 is provided on at least one of two side edges of the display panel 11 that are oppositely arranged in the first direction X. In some examples, the display module 1 includes a plurality of second driving circuit boards 14, and the plurality of second driving circuit boards 14 are provided on one of the two side edges of the display panel 11 that are oppositely arranged in the first direction X. In some other examples, as shown in FIG. 7, the display module 1 includes a plurality of second driving circuit boards 14. A part of the plurality of second driving circuit boards 14 are provided on one of the two side edges of the display panel 11 that are oppositely arranged in the first direction X, and the remaining part of the plurality of the second driving circuit boards 14 are provided on another one of the two side edges of the display panel 11 that are oppositely arranged in the first direction X.

As shown in FIG. 8B, each second driving circuit board 14 is located on the back surface 112 of the display panel 11, and an orthogonal projection of the second driving circuit board 14 on the backplane assembly 2 is located within a range of an orthogonal projection of the display panel 11 on the backplane assembly 2. The second driving circuit board 14 does not extend beyond the edge of the display panel 11, and is always shielded by the display panel 11 and the backplane assembly 2, and thus cannot be seen from the outside. Based on this, it is not required to design a corresponding structure at the flanging portion 321 of the edge-covering bracket 32 to shield and bypass the second driving circuit board(s) 14. For example, the second driving circuit board 14 includes a second film 141 and a gate driving IC 142 disposed on the second film 141, and the gate driving IC 142 is located on a side of the second film 141 away from the display panel 11. When the second driving circuit board 14 is fixed, the second film 141 is fixed to the back surface 112 of the display panel 11 facing the backplane assembly 2.

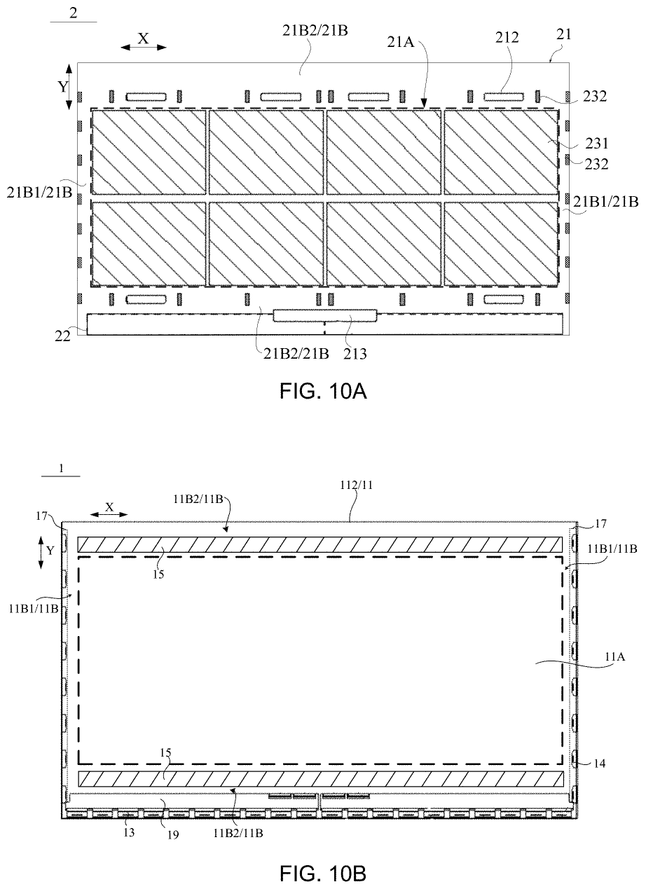

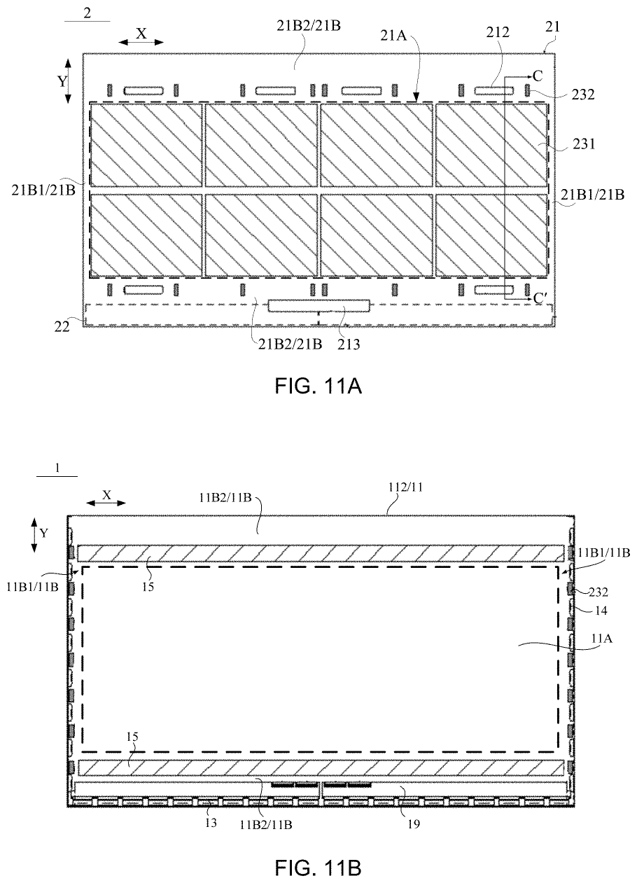

In some embodiments, as shown in FIGS. 10A and 11A, the backplane assembly 2 includes a backplane 21 and at least one connection structure (in order to distinguish it from other connection structures, the connection structure is referred to as a first connection structure 231 below) disposed on a side surface of the backplane 21 proximate to the display panel 11. The display panel 11 is fixed to the backplane 21 through the first connection structure 231.

In some embodiments, as shown in FIG. 13, the display device 100 has a central region 101 and an edge region 102 around the central region. Accordingly, as shown in FIGS. 10A and 11A, the backplane 21 has a backplane central region 21A and a backplane edge region 21B, and the backplane edge region 21B is around the backplane central region 21A. An orthogonal projection of the backplane central region 21A on a plane perpendicular to a thickness direction of the display device 100 is completely overlapped with an orthogonal projection of the central region 101 on the plane, and an orthogonal projection of the backplane edge region 21B on the plane is completely overlapped with an orthogonal projection of the edge region 102 on the plane. In this case, the first connection structure 231 is provided on the backplane 21 and located in the backplane central area 21A. Similarly, as shown in FIGS. 10B and 11B, the display module 1 has a panel central region 11A and a panel edge region 11B, and the panel edge region 11B is around the panel central region 11A. An orthogonal projection of the panel central region 11A on the plane is completely overlapped with the orthogonal projection of the central region 101 on the plane, and an orthogonal projection of the panel edge region 11B on the plane is completely overlapped with the orthogonal projection of the edge region 102 on the plane. In other words, the panel central region 11A directly faces the backplane central region 21A, and the panel edge region 11B directly faces the backplane edge region 21B. Here, the thickness direction of the display device 100 includes a direction pointing from the light exit surface 111 to the back surface 112 of the display panel 11, and a direction pointing from the back surface 112 to the light exit surface 111. The thickness direction of the bracket assembly 3 is parallel to the thickness direction of the display device 100.

In some examples, the central region 101 is a display region of the display device 100, and the edge region 102 is a peripheral region of the display device 100. In some other examples, an area of the central region 101 is slightly less than that of the display region of the display device 100, and the edge region 102 is other region of the display device 100. In some other examples, the area of the central region 101 is slightly greater than that of the display region of the display device 100, and the edge region 102 is other region of the display device 100.

In some examples, as shown in FIGS. 10B and 11B, the display module 1 further includes a control circuit board 19 disposed on the back surface 112 of the display panel 11. At least one first connection structure 231 is provided in the central region 101, and the control circuit board 19 is provided in the edge region 102 (that is, the control circuit board 19 is provided on the display panel 11, and is located in the panel edge region 11B).

In some examples, as shown in FIGS. 10A and 11A, the backplane assembly 2 further includes an insulating sheet 22 disposed on the side surface of the backplane 21 proximate to the display panel 11, and an orthogonal projection of the insulating sheet 22 on the display module 1 covers the control circuit board 19. The insulating sheet 22 may keep the control circuit board 19 insulated from the backplane 21, and when the backplane 21 is a metal backplane, it is possible to prevent the control circuit board 19 and the back plate 21 from being short-circuited, thereby ensuring the normal operation of the display panel 11.

The control circuit board 19 is connected to the first driving circuit board(s) 13 and the second driving circuit board(s) 14. In some examples, the control circuit board 19 is a printed circuit board assembly (PCBA). For example, the PCBA includes a printed circuit board (PCB), and a timing controller (TCON), a power management IC (PMIC) and other ICs or circuits that are disposed on the PCB.

In some examples, as shown in FIGS. 10A and 11A, the at least one first connection structure 231 includes a plurality of first connection structures 231, and the plurality of first connection structures 231 are arranged in an array.

In some examples, the first connection structure 231 is a magnetic attraction structure, and the first connection structure 231 is configured to fix the display module 1 and the backplane 21 by attraction. In some other examples, the first connection structure 231 is an adhesive structure, and the first connection structure 231 is configured to fix the display module 1 and the backplane 21 by adhesion.

In a case where the first connection structure 231 is the magnetic attraction structure, for example, the first connection structure 231 is a soft magnetic sheet. The soft magnetic sheet is a plate-like structure made of a material with weak magnetism, which is able to generate a slight magnetic attraction force and play a role of auxiliary fixation. For example, a material of the soft magnetic sheet includes a flexible material such as rubber. The flexible material is soft in property, and has a good buffer effect. Therefore, the first connection structure 231 made of the flexible material may prevent an impact on the display panel 11. In an assembling process of the display module 1 and the backplane assembly 2, the first connection structure 231 made of the flexible material also has advantages of being easily bent and being attached to the display panel 11.

In some embodiments, as shown in FIGS. 10A and 11A, the backplane assembly 2 further includes at least one second connection structure 232 disposed on the side surface of the backplane 21 proximate to the display panel 11, and the at least one second connection structure 232 is provided in the backplane edge region 21B. In some examples, the at least one second connection structure 232 includes a plurality of second connection structures 232, and the plurality of second connection structures 232 are arranged at intervals. In some examples, the second connection structure 232 is an adhesive structure. In some other examples, the second connection structure 232 is a magnetic attraction structure. In yet another examples, some of the plurality of second connection structures 232 are the adhesive structures, and some are the magnetic attraction structures.

In a case where the first connection structure 231 is the magnetic attraction structure and the second connection structure 232 is the adhesive structure, when the display module 1 is assembled with the backplane assembly 2, the display module 1 is first fixed to the backplane 21 by attraction through the first connection structure(s) 231 to realize alignment pre-assembly. Since the display module 1 is fixed to the backplane 21 by attraction through the magnetic attraction structure(s), a relative position of the display module 1 and the backplane 21 may be easily adjusted during the alignment pre-assembly, which reduces an assembly difficulty and improves an assembly accuracy. After the display module 1 and the backplane 21 are accurately positioned, the display panel 11 and the backplane 21 are further fixed by the plurality of second connection structures 232.

In this way, on one hand, it is possible to ensure that the display module 1 and the backplane 21 are firmly fixed together. On another hand, compared to that the display module 1 is fixed to the backplane 21 through an entire adhesive layer, which may result in an excessive stress of the display panel 11 and break the display panel 11, this problem may be avoided through cooperation of the magnetic attraction structure and the adhesive structure in the embodiments of the present disclosure. On yet another hand, since a magnetic attraction force generated by the magnetic attraction structure between the display panel 11 and the backplane 21 is mainly distributed in a normal direction (i.e., the thickness direction of the display device 100), and the magnetic attraction force is weak in a tangential direction (i.e., a direction perpendicular to the thickness direction of the display device 100), in a transportation process of the display device 100, vibration acting on the display panel 11 and the backplane 21 may be absorbed through slight deformations, in the tangential direction, of the display panel 11 and the backplane 21 in a region where the magnetic attraction structure(s) are located, thereby preventing the display panel 11 from being damaged.

In some examples, the backplane 21 is a metal backplane. In some examples, a material of the backplane 21 includes one of iron (Fe), cobalt (Co), nickel (Ni) and alloys thereof, rare earth and alloys thereof, or a compound of manganese (Mn).

In a case where the first connection structure 231 is the magnetic attraction structure and the second connection structure 232 is the magnetic attraction structure, in some examples, a magnetic attraction force of the first connection structure 231 is less than a magnetic attraction force of the second connection structure 232. In this way, it is possible to reduce a stress of the panel central region 11A in a case of ensuring that the display module 1 and the backplane 21 are accurately aligned and firmly fixed. Especially in the assembly process of the curved display device, a large magnetic attraction force is applied to the panel edge region 11B to make the display panel 11 reach a predetermined overall curvature. A small magnetic attraction force is applied to the panel central region 11A to make the display panel 11 be well attached to the backplane 21 in the panel central region 11A, so as to reach a predetermined local curvature and a smooth bending transition. Thus, the display panel 11 is capable of being well bent to be attached to the curved backplane, and the stress concentration and excessive bending of the panel central region 11A are avoided to ensure that the display panel 11 is not damaged in the assembly process.

In the case where the second connection structure 232 is the magnetic attraction structure, in some examples, a material of the second connection structure 232 includes metal. For example, the material of the second connection structure 232 includes one of iron (Fe), cobalt (Co), nickel (Ni) and alloys thereof, rare earth and alloys thereof, or a compound of manganese (Mn). For example, the second connection structure 232 is a neodymium iron boron magnet.

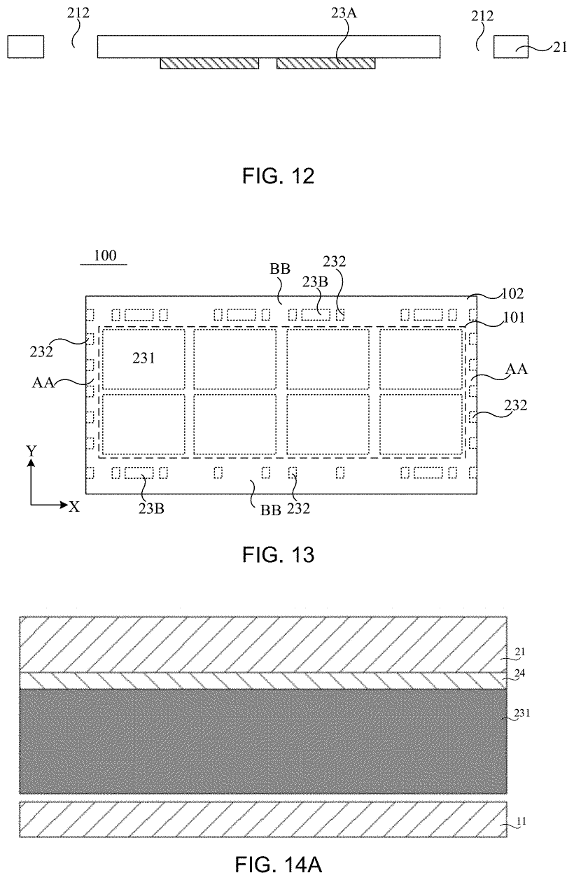

In some examples, as shown in FIGS. 10A, 11A and 12, the backplane 21 is provided with a plurality of dispensing through holes 212. The dispensing through holes 212 are configured to inject a glue between the backplane 21 and the display module 1, so as to further fix the display module 1 and the backplane 21.

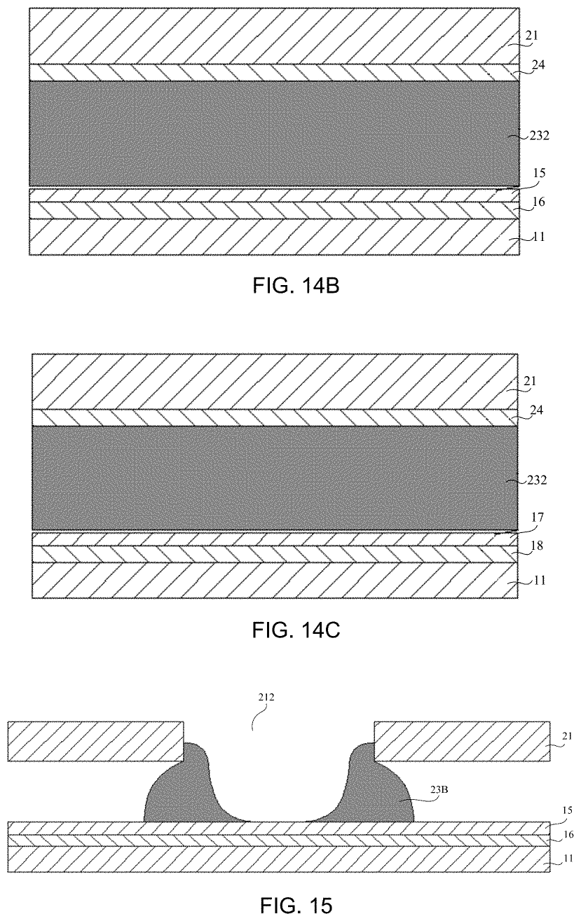

In some examples, as shown in FIG. 14A, the backplane assembly 2 further includes a first adhesive layer 24. The first adhesive layer 24 has two adhesive surfaces, one adhesive surface is adhered to the backplane 21, and another adhesive surface is adhered to the at least one first connection structure 231, so as to make the first connection structure(s) 231 be fixed on the backplane 21. Of course, as shown in FIGS. 14B and 14C, in a case where the backplane assembly 2 further includes the second connection structure(s) 232, the second connection structure(s) 232 are also fixed on the backplane 21 through the first adhesive layer 24.

For example, the at least one first connection structure 231 includes the plurality of first connection structures 231, and the first adhesive layer 24 includes a plurality of first adhesive blocks, and a surface of each first adhesive block is adhered to the backplane 21, and another surface of each first adhesive block is adhered to a corresponding first connection structure 231. For example, the first adhesive layer 24 may be a double-sided tape. For another example, the first adhesive layer 24 further includes a plurality of second adhesive blocks, and a surface of each second adhesive block is adhered to the backplane 21, and another surface of each second adhesive block is adhered to a corresponding second connection structure 232.

In order to ensure that the first connection structure 31 is firmly adhered to the backplane 21, an adhesive force between the first adhesive layer 24 and the backplane 21 may be greater than a magnetic attraction force between the first connection structure 231 and the display panel 11. In this way, it is possible to prevent the first connection structure 231 and the backplane 21 from being separated due to the magnetic attraction force. Similarly, the adhesive force between the first adhesive layer 24 and the backplane 21 may be greater than a magnetic attraction force between the second connection structure 232 and the display panel 11.

In some embodiments, as shown in FIG. 13, the edge region 102 includes two first edge sub-regions AA disposed on two opposite sides of the central region 101 in the first direction X, and two second edge sub-regions BB disposed on two opposite sides of the central region 101 in the second direction Y. Corresponding to the two first edge sub-regions AA and the two second edge sub-regions BB, as shown in FIGS. 10A and 11A, the backplane edge region 21B is also divided into two first backplane edge sub-regions 21B1 disposed on two opposite sides of the backplane central region 21A in the first direction X, and two second backplane edge sub-regions 21B2 disposed on two opposite sides of the central region 101 in the second direction Y. An orthogonal projection of each first backplane edge sub-region 21B1 on the plane perpendicular to the thickness direction of the display device 100 is completely overlapped with an orthogonal projection of a corresponding first edge sub-region AA on the plane, and an orthogonal projection of each second backplane edge sub-region 21B2 on the plane is completely overlapped with an orthogonal projection of a corresponding second edge sub-region BB on the plane.

The plurality of second connection structures 232 may be divided into a first group of connection structures and a second group of connection structures. The first group of connection structures includes a part of the plurality of second connection structures 232, and the second group of connection structures includes the remaining part of the plurality of second connection structures 232. A plurality of second connection structures 232 are both included in the first group of connection structures and the second group of connection structures. In some examples, the first group of connection structures are provided in the two first backplane edge sub-regions 21B1. That is, some second connection structures 232 in the first group of connection structures are provided in one first backplane edge sub-region 21B1, and the remaining second connection structure(s) 232 are provided in another first backplane edge sub-region 21B1. The second group of connection structures are provided in the two second edge sub-regions 21B2. That is, some second connection structures 232 in the second group of connection structures are provided in one second backplane edge sub-region 21B2, and the remaining second connection structure(s) 232 are provided in another second backplane edge sub-region 21B2.

Based on this, the magnetic attraction forces generated by the plurality of second connection structures 232 in the two first edge sub-regions AA and the two second edge sub-regions BB are uniformly distributed, so that the display panel 11 and the backplane 21 are able to be well fixed by attraction in the entire edge region 102, so as to avoid local loosening or warping.

In some examples, as shown in FIGS. 10A and 11A, some of the plurality of dispensing through holes 212 are provided in one second backplane edge sub-region 21B2, and these dispensing through holes 212 are arranged at intervals in the first direction X. The remaining dispensing through holes 212 of the plurality of dispensing through holes 212 are provided in another second backplane edge sub-region 21B2, and the remaining dispensing through holes 212 are arranged at intervals in the first direction X. In this way, when the backplane 21 is bent, the plurality of dispensing through holes 212 disposed in the first direction X may also release a stress generated due to the bending of the backplane 21, so as to avoid an excessive stress of the backplane 21.

As shown in FIGS. 10B, 11B and 14B, in some embodiments, the display module 1 further includes two auxiliary magnetic attraction members 15 and a second adhesive layer 16. The two auxiliary magnetic attraction members 15 are provided in the panel edge region 11B, and are provided on two opposite sides of the panel central region 11A, respectively. The second adhesive layer 16 has two adhesive surfaces, one adhesive surface is adhered to the back surface 112 of the display panel 11, and another adhesive surface is adhered to the two auxiliary magnetic attraction members 15, so that the auxiliary magnetic attraction members 15 are firmly fixed to the display panel 11. In this case, the second connection structure 232 is the magnetic attraction structure.

It will be noted that FIG. 14B only shows that the another adhesive surface of the second adhesive layer 16 is adhered to one auxiliary magnetic attraction member 15, and an arrangement of another auxiliary magnetic attraction member 15 is same as the arrangement of this auxiliary magnetic attraction member 15 shown in FIG. 14B. In addition, since the two auxiliary magnetic attraction members 15 are provided on the two opposite sides of the panel central region 11A, the second adhesive layer 16 may be only provided in a region where the two auxiliary magnetic attraction members 15 are located.

Corresponding to the two first edge sub-regions AA and the two second edge sub-regions BB, as shown in FIGS. 10B and 11B, the panel edge region 11B is also divided into two first panel edge sub-regions 11B1 disposed on two opposite sides of the panel central region 11A in the first direction X, and two second panel edge sub-regions 11B2 disposed on two opposite sides of the panel central region 11A in the second direction Y. An orthogonal projection of each first panel edge sub-region 11B1 on the plane perpendicular to the thickness direction of the display device 100 is completely overlapped with an orthogonal projection of a corresponding first edge sub-region AA on the plane, and an orthogonal projection of each second panel edge sub-region 11B2 on the plane is completely overlapped with an orthogonal projection of a corresponding second edge sub-region BB on the plane.

In some examples, as shown in FIGS. 10B and 11B, the two auxiliary magnetic attraction members 15 are provided in the two second panel edge sub-regions 11B2, respectively. Orthogonal projections of all second connection structures 232 of the second group of connection structures located in each second backplane edge sub-region 21B2 on the display panel 11, are located within a range of an orthogonal projection of a corresponding auxiliary magnetic attraction member 15 on the display panel 11. This auxiliary magnetic attraction member 15 is configured to be magnetically attracted to the all second connection structures 232.

An adhesive force generated by the second adhesive layer 16 between the auxiliary magnetic attraction member 15 and the display panel 11 is greater than a magnetic attraction force between the auxiliary magnetic attraction member 15 and the second connection structure 232, so as to prevent the auxiliary magnetic attraction member 15 and the display panel 11 from being separated due to the magnetic attraction force, and to ensure a reliability of the connection between the display panel 11 and the auxiliary magnetic attraction member 15. In some examples, the second adhesive layer 16 may be a double-sided tape.

In some examples, the auxiliary magnetic attraction member 15 is a metal sheet. For example, a thickness of the metal sheet is approximately in a range from 0.25 mm to 0.35 mm. For example, the thickness of the metal sheet is 0.25 mm, 0.28 mm, 0.3 mm, 0.32 mm, or 0.35 mm. A thickness direction of the metal sheet is parallel to the thickness direction of the display device 100.

Considering that a thickness of a metal layer in the display panel 11 is usually less than 0.1 mm, and a magnetic attraction force between the metal layer and the second connection structure 232 is small, and thus, by providing the auxiliary magnetic attraction member 15, the second connection structure 232 of the second group of connection structures may be strong in magnetic attraction force with the auxiliary magnetic attraction member 15 and the metal layer in the display panel 11, thereby increasing the attraction force between the display panel 11 and the backplane 21, so that the fixation between the display panel 11 and the backplane 21 is reliable. In addition, by properly setting a thickness of the auxiliary magnetic attraction member 15, an influence on the thickness of the display device 100 may be ignored, and the bending of the display panel 11 is not affected for the curved display device.

In some examples, as shown in FIGS. 10B and 11B, the control circuit board 19 is provided in the second panel edge sub-region 11B2. In some other examples, the at least one first driving circuit board 13 and the control circuit board 19 are provided in the same second panel edge sub-region 11B2. In some other examples, the at least one second driving circuit board 14 includes a plurality of second driving circuit boards 14. A part of the plurality of second driving circuit boards 14 are provided in one first panel edge sub-region 11B1, and the remaining part of the plurality of second driving circuit boards 14 are provided in another first panel edge sub-region 11B1.

In some examples, as shown in FIG. 15, the display device 100 further includes a plurality of adhesive structures 23B. Each adhesive structure 23B is located at a position of the dispensing through hole 212, and is located between the two auxiliary magnetic attraction members 15 and the backplane 21. An adhesive material is injected into the dispensing through hole 212 by a dispensing process, and the adhesive material is able to be filled between the display panel 11 and the backplane 21 along an edge of the dispensing through hole 212, so that the adhesive structure 23B is formed after the adhesive material is cured.

Here, the adhesive structures 23B are not in direct contact with the display panel 11. On one hand, it is possible to avoid the damage to the structure of the display panel 11. On another hand, when the display panel 11 and the backplane 21 are required to be separated, the adhesive structures 23B may be directly cut without damaging the display panel 11, so that the disassembly is safe and convenient.

In some examples, a material of the adhesive structure 23B includes a neutral transparent glass glue. Since the neutral transparent glass glue is in a semi-liquid and semi-solid state after being applied to the edge of the dispensing through hole 212, and it is required to take a period of time to solidify, coating the neutral transparent glass glue has a certain fault tolerance, and a coating position may be adjusted before the glass glue is solidified. After the neutral transparent glass glue is solidified into the adhesive structure 23B, the adhesive structure 23B has a strong viscosity and a certain elasticity, which facilitates the fixation between the display panel 11 and the backplane 21. In addition, when the display panel 11 is required to be removed from the backplane 21, the adhesive structures 23B may be heated to be softened, and then the adhesive structures 23B are peeled off with a tool such as a blade, so as to facilitate the removal of the display panel 11 from the backplane 21, thereby improving the convenience of the disassembly, assembly, and maintenance of the display panel 11.

In some embodiments, as shown in FIGS. 10B and 14C, the display module 1 further includes two auxiliary connection structures 17 and a third adhesive layer 18. The two auxiliary connection structures 17 are provided in the panel edge region 11B, and are provided on two opposite sides of the panel central region 11A, respectively. The third adhesive layer 18 has two adhesive surfaces, one adhesive surface is adhered to the display panel 11, and another adhesive surface is adhered to the two auxiliary connection structures 17, so that the auxiliary connection structures 17 and the display panel 11 are firmly fixed. It will be noted that FIG. 14C only shows that the another adhesive surface of the third adhesive layer 18 is adhered to one auxiliary connection structure 17, and an arrangement of another auxiliary connection structure 17 is same as the arrangement of this auxiliary connection structure 17 shown in FIG. 14C. In addition, since the two auxiliary connection structures 17 are respectively provided on the two opposite sides of the panel central region 11A, the third adhesive layer 18 may be only provided in a region where the two auxiliary connection structures 17 are located.

In some examples, as shown in FIG. 10B, the two auxiliary connection structures 17 are provided in the two first panel edge sub-regions 11B1, respectively. Orthogonal projections of all second connection structures 232 of the first group of connection structures located in each first backplane edge sub-region 21B1 on the display panel 11, are located within a range of an orthogonal projection of a corresponding auxiliary connection structure 17 on the display panel 11. The auxiliary connection structure 17 is configured to be magnetically attracted to all second connection structures 232 located in the first backplane edge sub-region 21B1.

An adhesive force generated by the third adhesive layer 18 between the auxiliary connection structure 17 and the display panel 11 is greater than a magnetic attraction force between the auxiliary connection structure 17 and the second connection structure 232, so as to prevent the auxiliary connection structure 17 and the display panel 11 from being separated due to the magnetic attraction force, and to ensure a reliability of the connection between the display panel 11 and the auxiliary connection structure 17. In some examples, the third adhesive layer 18 is a double-sided tape.

In some examples, the auxiliary connection structure 17 is a metal sheet. For example, a thickness of the metal sheet is approximately in a range from 0.25 mm to 0.35 mm, such as 0.25 mm, 0.28 mm, 0.3 mm, 0.32 mm, or 0.35 mm. A thickness direction of the metal sheet is parallel to the thickness direction of the display device 100.

Considering that the thickness of the metal layer in the display panel 11 is usually less than 0.1 mm, and the magnetic attraction force between the metal layer and the second connection structures 232 is small, and thus, by providing the auxiliary connection structure 17, the second connection structure 232 of the first group of connection structures may be strong in magnetic attraction force with the auxiliary connection structure 17 and the metal layer in the display panel 11, thereby increasing the attraction force between the display panel 11 and the backplane 21, so that the fixation between the display panel 11 and the backplane 21 is reliable. In addition, by properly setting a thickness of the auxiliary connection structure 17, an influence on the thickness of the display device 100 may be ignored, and the bending of the display panel 11 is not affected for the curved display device.

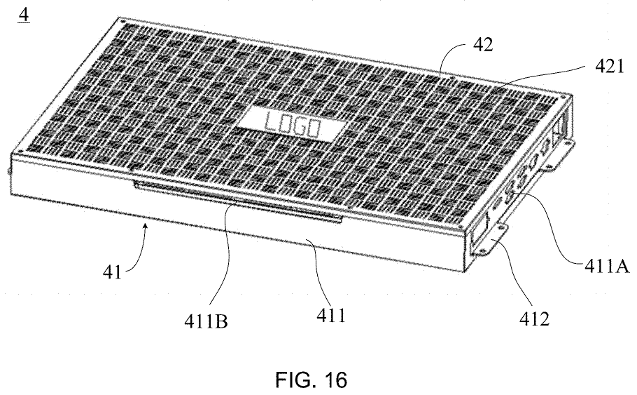

In some embodiments, as shown in FIG. 16, at least one side wall of the system circuit assembly 4 has a plurality of external interfaces 411A. For example, these external interfaces 411A are exposed in an outer surface of the display device 100, so that a user may quickly connect an end of an external signal line to a corresponding external interface 411A of the system circuit assembly 4, and another end of the external signal line may be connected to a corresponding interface of an external device such as a computer host, a game console, or a mobile communication device. For example, these external interfaces may include a universal serial bus (USB) interface, a high definition multimedia interface (HDMI), a video graphics array (VGA) interface, a thunderbolt interface, and other types of interfaces.

In some examples, as shown in FIG. 3, a side of at least one support member 311 away from the backplane assembly 2 is provided with a groove 311C, and the groove 311C penetrates through the support member 311 in the second direction Y. The groove 311C is configured to allow external signal lines to enter the bracket assembly 3.

In some examples, as shown in FIG. 16, a side wall of the system circuit assembly 4 has a wire passing port 411B, and internal signal lines connected to the display module 1 pass through the wire passing port 411B to be electrically connected to the system circuit assembly 4. Accordingly, as shown in FIGS. 10A and 11A, the backplane assembly 2 has an opening 213 configured to allow the internal signal lines to pass through to be electrically connected to the display module 1, so as to facilitate the routing of the internal signal lines. Here, the system circuit assembly 4 provides signals to the display module 1 through the internal signal lines, so as to make the display module 1 display.

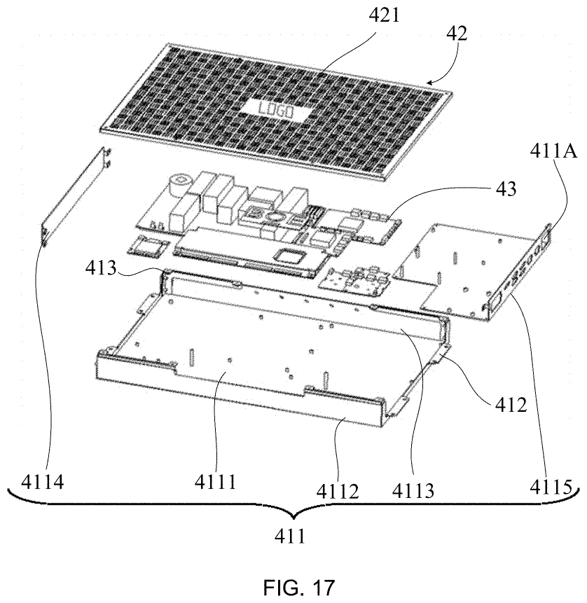

In some embodiments, as shown in FIGS. 16 and 17, the system circuit assembly 4 includes a carrying box 41, a box cover 42, and a system circuit board 43. The carrying box 41 includes a carrying box body 411 and a plurality of fixing portions 412 disposed on at least two opposite side edges of the carrying box body 411. The plurality of fixing portions 412 extend outside the carrying box body 411, and the plurality of fixing portions 412 are configured to be connected to the bracket assembly 3. For example, the carrying box body 411 may be embedded in the hollow region 3A of the bracket assembly 3, and the plurality of fixing portions 412 are connected to the bracket assembly 3.

The box cover 42 is fixed to the carrying box 41 to form a receiving chamber, and the system circuit board 43 is provided in the receiving chamber. In some examples, a plurality of heat dissipation holes 421 are provided on the box cover 42 to dissipate heat generated by the system circuit board 43, so as to reduce heat accumulation and temperature rise caused by the heat accumulation. In some examples, the carrying box 41 may be a split structure or an integrated structure.

In some examples, as shown in FIG. 17, the carrying box body 411 includes a bottom plate 4111, a first side wall 4112, and a second side wall 4113. The bottom plate 4111 includes a first edge and a second edge that are oppositely arranged, and a third edge and a fourth edge that are oppositely arranged. The first side wall 4112 and the second side wall 4113 are disposed at the first edge and the second edge, respectively, and the first side wall 4112 and the second side wall 4113 are connected to the bottom plate 4111 as a whole. At least one of the plurality of fixing portions 412 is connected to the third edge as a whole, and the remaining fixing portion(s) 412 of the plurality of fixing portions 412 are connected to the fourth edge as a whole.

In some examples, as shown in FIG. 17, the carrying box 41 further includes a third side wall 4114 and a fourth side wall 4115. The third side wall 4114 and the fourth side wall 4115 are disposed at the third edge and the fourth edge, respectively. The third side wall 4114 at the third edge is fixed to the first side wall 4112 and the second side wall 4113, and/or the bottom plate 4111. The at least one fixing portion 412 at the third edge is located on a side of the third side wall 4114 away from the fourth side wall 4115. The fourth side wall 4115 at the fourth edge is fixed to the first side wall 4112 and the second side wall 4113, and/or the bottom plate 4111. The remaining fixing portion(s) 412 at the fourth edge are located on a side of the fourth side wall 4115 away from the third side wall 4114. In some examples, the plurality of external interfaces 411A are disposed in the fourth side wall 4115.

In some examples, as shown in FIG. 17, the carrying box 41 further includes a plurality of connection fixing members 413 disposed on the first side wall 4112 and the second side wall 4113, and the plurality of connection fixing members 413 are configured to make the box cover 42 be fixed to the first side wall 4112 and the second side wall 4113. For example, the connection fixing member 413 is a fixing sheet with a threaded hole. The box cover 42 is provided with a via, and a threaded rod of a bolt is in threaded connection with the threaded hole of the fixing sheet after passing through the via. The box cover 42 is pressed against the first side wall 4112 and the second side wall 4113 through a head of the bolt. For example, the number of the plurality of connection fixing members 413 is four, two of them are disposed at two ends of the first side wall 4112, and another two are disposed at two ends of the second side wall 4113, so that the four connection fixing members 413 are located at four corners of the carrying box 41. For example, the plurality of connection fixing members 413 are welded to the first side wall 4112 and the second side wall 4113.

An assembling process of the display device 100 in the embodiments of the present disclosure will be described briefly below. The following description is only for explanation, and is not for limitation. First, the backplane assembly 2 is aligned with the bracket assembly 3, and the two are connected and fixed after being accurately positioned. Then, the display module 1 is fixed to a surface of the backplane assembly 2 away from the bracket assembly 3. Finally, the system circuit assembly 4 is fixed in the bracket assembly 3, and then the display module 1 is wired to the system circuit assembly 4 to complete the assembly of the display device 100.

The foregoing descriptions are merely specific implementations of the present disclosure, but the protection scope of the present disclosure is not limited thereto. Changes or replacements that any person skilled in the art could conceive of within the technical scope of the present disclosure shall be included in the protection scope of the present disclosure. Therefore, the protection scope of the present disclosure shall be subject to the protection scope of the claims.

1. A display device, comprising:
a display module including a display panel, the display panel having a light exit surface and a back surface opposite to the light exit surface;
a backplane assembly disposed on a side of the display panel facing away from the light exit surface, the backplane assembly being fixed to the display module;
a bracket assembly, a surface of the backplane assembly away from the display module being fixed to the bracket assembly, and the bracket assembly having a hollow region; and
a system circuit assembly fixed in the hollow region of the bracket assembly, the system circuit assembly being electrically connected to the display module, and the system circuit assembly being configured to provide signals to the display module to make the display module display.

2. The display device according to claim 1, wherein at least one side wall of the system circuit assembly has a plurality of external interfaces;
a side wall of the system circuit assembly has a wire passing port, and internal signal lines connected to the display module pass through the wire passing port to be electrically connected to the system circuit assembly; and the backplane assembly has an opening configured to allow the internal signal lines to pass through to be electrically connected to the display module.

3. The display device according to claim 2, wherein the system circuit assembly includes a carrying box, a box cover, and a system circuit board;
the carrying box includes a carrying box body and a plurality of fixing portions disposed on at least two opposite side edges of the carrying box body; the plurality of fixing portions extend outside the carrying box body, and the plurality of fixing portions are configured to be connected to the bracket assembly;
the box cover is fixed to the carrying box to form a receiving chamber; and
the system circuit board is disposed in the receiving chamber.

4. The display device according to claim 3, wherein a plurality of heat dissipation holes are disposed in the box cover.

5. The display device according to claim 3, wherein the carrying box body includes a bottom plate, a first side wall and a second side wall; the bottom plate includes a first edge and a second edge that are oppositely arranged, and a third edge and a fourth edge that are oppositely arranged; the first side wall and the second side wall are disposed at the first edge and the second edge, respectively, and the first side wall and the second side wall are connected to the bottom plate as a whole; at least one of the plurality of fixing portions is connected to the third edge as a whole, and a remaining fixing portion of the plurality of fixing portions is connected to the fourth edge as a whole;
the carrying box further includes a third side wall and a fourth side wall; the third side wall and the fourth side wall are disposed at the third edge and the fourth edge, respectively; the third side wall located at the third edge is fixed to the first side wall and the second side wall, and/or the bottom plate; the fourth side wall located at the fourth edge is fixed to the first side wall and the second side wall, and/or the bottom plate; and
the plurality of external interfaces are disposed in the fourth side wall.

6. The display device according to claim 5, wherein the carrying box further includes a plurality of connection fixing members disposed on the first side wall and the second side wall, and the plurality of connection fixing members are configured to make the box cover be fixed to the first side wall and the second side wall.

7. The display device according to claim 1, wherein the bracket assembly includes a support portion, two edge-covering brackets, and at least two detachable fixing structures;
the support portion extends in a first direction;
the two edge-covering brackets are disposed on two sides of the support portion in the first direction, respectively; each edge-covering bracket extends in a second direction, and an end of the edge-covering bracket away from the support portion is a flanging portion; the first direction is an extending direction of a side of the light exit surface, the second direction is an extending direction of another side of the light exit surface, and the side and the another side are two adjacent sides of the light exit surface;
the edge-covering bracket is fixed to a corresponding end of the support portion through at least one detachable fixing structure; one of the edge-covering bracket and an end of the support portion has at least one through hole, and each detachable fixing structure passes through a through hole to be fixed to another one; an outer wall of the detachable fixing structure and a hole wall of the through hole have a gap therebetween, so as to enable the edge-covering bracket and the support portion to be relatively moved when the support portion is assembled with the edge-covering bracket; and
the surface of the backplane assembly away from the display module is in contact with and fixed to the support portion, and the two edge-covering brackets are located at two side edges of the display module in the first direction.

8. The display device according to claim 7, wherein the edge-covering bracket further includes a connection portion, and the connection portion and the flanging portion form an L-shaped structure;
the connection portion includes a first connection sub-portion and a second connection sub-portion, and the first connection sub-portion is located between the second connection sub-portion and the flanging portion, and is connected to the second connection sub-portion and the flanging portion; and
the second connection sub-portion and the end of the support portion are stacked in a thickness direction of the bracket assembly, and the first connection sub-portion is non-overlapped with the support portion in the thickness direction of the bracket assembly; and the at least one through hole is disposed in the second connection sub-portion.

9. The display device according to claim 7, wherein the support portion includes at least two support members, and any two adjacent support members of the at least two support members are arranged at an interval in the second direction, and an end of each support member is fixed to the edge-covering bracket through at least one detachable fixing structure;
the bracket assembly further includes at least one bracket disposed between the two edge-covering brackets, and each bracket extends in the second direction; the at least one bracket is fixedly connected to the at least two support members; and
the system circuit assembly is disposed in the hollow region enclosed by two adjacent support members and the at least one bracket.

10. The display device according to claim 9, wherein the support member is in an arcuate shape, and a surface of the support member that is in contact with the surface of the backplane assembly away from the display module is an arc-shaped surface; an extending direction of a curved side of the arc-shaped surface is parallel to the first direction; and the arc-shaped surface and the flanging portion are located on a same side of the bracket assembly.

11. The display device according to claim 9, wherein a side of at least one support member away from the backplane assembly is provided with a groove, and the groove penetrates through the support member in the second direction; and/or,
the support member is further provided with at least one heat dissipation window, and the at least one heat dissipation window penetrates through the support member in the second direction.

12. The display device according to claim 1, wherein a plurality of mounting holes are disposed in a surface of the bracket assembly facing the backplane assembly; and
a plurality of protrusions are disposed on a surface of the backplane assembly facing the bracket assembly, and the plurality of protrusions are configured to be matched with the plurality of mounting holes.

13. The display device according to claim 7, wherein the display module further includes two protection bezels, and the two protection bezels are disposed on two side edges of the display panel that are oppositely arranged in the second direction; and
each protection bezel is fixed to one of two side faces of the display panel that are oppositely arranged in the second direction.

14. The display device according to claim 13, wherein the protection bezel includes a side bezel, a clamping portion connected to the side bezel, and a position-limiting platform disposed on a side of the clamping portion away from the display panel; and
the clamping portion is disposed between the backplane assembly and the display panel; the side bezel is fixed to the side face of the display panel; and an edge portion of the backplane assembly is disposed on a surface of the clamping portion away from the display panel.

15. The display device according to claim 14, wherein the display module further includes at least one first driving circuit board disposed on at least one of two side edges of the display panel that are oppositely arranged in the second direction; each first driving circuit board is located on the back surface of the display panel, and extends beyond an edge of the display panel; and the first driving circuit board is located between the side bezel, the clamping portion and the display panel.

16. The display device according to claim 7, wherein the display module further includes at least one second driving circuit board disposed on at least one of two side edges of the display panel that are oppositely arranged in the first direction, and each second driving circuit board is located on the back surface of the display panel; and an orthogonal projection of the second driving circuit board on the backplane assembly is located in a range of an orthogonal projection of the display panel on the backplane assembly.

17. The display device according to claim 1, wherein the backplane assembly includes a backplane and at least one connection structure disposed on a side surface of the backplane proximate to the display panel; and
the display panel is fixed to the backplane through the at least one connection structure.

18. The display device according to claim 17, wherein the display module further includes a control circuit board disposed on the back surface of the display panel; and
the display device has a central region and an edge region around the central region, the at least one connection structure is disposed in the central region, and the control circuit board is disposed in the edge region.

19. The display device according to claim 18, wherein the backplane assembly further includes an insulating sheet disposed on the side surface of the backplane proximate to the display panel, and an orthogonal projection of the insulating sheet on the display module covers the control circuit board.

20. The display device according to claim 17, wherein the at least one connection structure includes a plurality of connection structures, and the plurality of connection structures are arranged in an array.
